(19) United States
(12) Patent Application Publication
(10) Pub. No.: US 2012/0326051 A1
(43) Pub. Date: Dec. 27, 2012

(54) EXPOSURE APPARATUS AND DEVICE FABRICATION METHOD

(75) Inventor: Shinji Uchida, Utsunomiya-shi (JP)

(73) Assignee: CANON KABUSHIKI KAISHA, Tokyo (JP)

(21) Appl. No.: 13/516,424

(22) PCT Filed: Jun. 9, 2011
(86) PCT No.: PCT/JP2011/063753

§ 371 Date: Jun. 15, 2012

(30) Foreign Application Priority Data
Jun. 25, 2010 (JP) 2010-145529

(51) Int. Cl. G21K 5/00

(52) U.S. Cl. 250/396 ML

(57) ABSTRACT

The present invention provides an exposure apparatus which forms a pattern on a substrate, the apparatus including an electron optical system configured to guide a charged particle beam onto the substrate, a stage configured to hold the substrate, an electromagnetic actuator configured to drive the stage, a magnetic shield which is placed in the stage so as to surround the electromagnetic actuator, a measurement member configured to measure a position of the stage, a coil member configured to generate a magnetic field on a path of the charged particle beam between the electron optical system and the substrate, and a control member configured to control the coil member so as to reduce a fluctuation of the magnetic field on the path, the magnetic field on the path fluctuating while the stage being driven by the electromagnetic actuator, based on the position of the stage measured by the measurement member.

### TECHNICAL FIELD

The present invention relates to an exposure apparatus and a device fabrication method.

### BACKGROUND ART

A lithography technique of transferring the pattern of a mask (reticle) onto a substrate such as a wafer is employed to fabricate a semiconductor device. Since the mask used for the lithography technique must have a pattern with an extremely high dimensional accuracy, an electron beam exposure apparatus (charged particle beam exposure apparatus) is used to fabricate this mask. An electron beam exposure apparatus is also used to directly draw a pattern on a substrate without using a mask.

An electron beam exposure apparatus generally includes an electron gun unit for emitting an electron beam, an electron optical system (charged particle beam optical system) for guiding the electron beam from the electron gun unit onto a substrate, a stage for driving the substrate relative to the electron beam, and a deflector for positioning the electron beam guided on the substrate.

The electron beam exposure apparatus has extremely high response characteristics to electron beam positioning. Therefore, it is a common practice to provide the apparatus with a feedback control system which measures the orientation or positional shift of the stage and feeds back the measurement result to electron beam positioning by the deflector, instead of enhancing the mechanical control characteristics of the stage. Also, the stage is placed in a vacuum chamber and is designed as a contact type such as a roller guide or a ball screw actuator and made of a non-magnetic material so as not to generate a fluctuation of a magnetic field (magnetic field fluctuation) which adversely affects electron beam positioning.

On the other hand, to avoid problems such as dust generation and deformation of a contact stage, Japanese Patent No. 4234768 proposes a stage including a non-contact electromagnetic actuator. However, the electromagnetic actuator causes a magnetic field fluctuation, so a magnetic shield surrounds the electromagnetic actuator to achieve high positioning accuracy while reducing any leakage magnetic field fluctuation generated by the stage in Japanese Patent No. 4234768. Nevertheless, in Japanese Patent No. 4234768, as the thrust of the electromagnetic actuator improves to comply with a demand for speeding up the stage, the electromagnetic actuator becomes larger and the leakage magnetic field fluctuation, in turn, becomes larger, so the magnetic shield also becomes larger and thicker.

Also, Japanese Patent Laid-Open No. 2003-173755 discloses a magnetic field canceller, as shown in FIG. 9, as a technique which copes with a leakage magnetic field fluctuation generated by the electromagnetic actuator. The magnetic field canceller shown in FIG. 9 uses a magnetic field sensor 1010 to detect a leakage magnetic field generated by the electromagnetic actuator, and performs feedback control so as to generate a cancelling magnetic field by a cancelling coil 1020, based on the detected value. In this case, to generate a cancelling magnetic field by the cancelling coil 1020 based on the value detected by the magnetic field sensor 1010, the detection range of the magnetic field sensor 1010 must be set in correspondence with the leakage magnetic field (magnetic field fluctuation) generated by the electromagnetic actuator.

In recent years, as a demand has arisen for a further speedup of a stage and a substrate becomes larger, an electromagnetic actuator and a magnetic shield also become larger. Also, a leakage magnetic field generated by an electron optical system is always present in the space between the electron optical system and the substrate, so, when a magnetic shield made of a high magnetic permeability material moves within the leakage magnetic field, the magnetic field in the space between the electron optical system and the substrate is disturbed, thus generating a magnetic field fluctuation. This magnetic field fluctuation becomes larger (that is, has a larger amplitude) with an increase in size of the magnetic shield.

Unfortunately, in the prior arts, as the magnetic field fluctuation has a larger amplitude, it falls outside the detection range of the magnetic field sensor. This often makes it impossible to detect a magnetic field fluctuation due to an insufficient detection range. Hence, a magnetic field fluctuation with a large amplitude cannot be cancelled simply by detecting the magnetic field fluctuation by the magnetic field sensor and performing feedback control so as to generate a cancelling magnetic field based on the detected value. In this case, the use of a magnetic sensor having a wide detection range in correspondence with a magnetic field fluctuation with a large amplitude is plausible, but such a magnetic sensor having a wide detection range generally has a low detection resolution and therefore cannot cancel the magnetic field fluctuation with high accuracy.

### SUMMARY OF INVENTION

The present invention provides a technique advantageous to reduce a magnetic field fluctuation generated upon driving a stage.

According to one aspect of the present invention, there is provided an exposure apparatus which forms a pattern on a substrate using a charged particle beam, the apparatus including an electron optical system configured to guide the charged particle beam onto the substrate, a stage configured to hold the substrate, an electromagnetic actuator configured to drive the stage, a magnetic shield which is placed in the stage so as to surround the electromagnetic actuator, a measurement member configured to measure a position of the stage, a coil member configured to generate a magnetic field on a path of the charged particle beam between the electron optical system and the substrate, and a control member configured to control the coil member so as to reduce a fluctuation of the magnetic field on the path, the magnetic field on the path fluctuating while the stage being driven by the electromagnetic actuator, based on the position of the stage measured by the measurement member.

Further features of the present invention will become apparent from the following description of exemplary embodiments with reference to the attached drawings.

### BRIEF DESCRIPTION OF DRAWINGS

FIG. 1 is a view showing the arrangement of an exposure apparatus according to an aspect of the present invention.

FIGS. 2A to 2C are views for explaining a magnetic field fluctuation on the electron beam path between an electron optical system and a substrate in the exposure apparatus shown in FIG. 1.

FIG. 3 is a graph illustrating an example of the relationship between the position of a stage and the disturbance magnetic field fluctuation on the electron beam path between the electron optical system and the substrate in the exposure apparatus shown in FIG. 1.

FIG. 4 is a block diagram showing a control configuration for reducing a magnetic field fluctuation on the electron beam path between the electron optical system and the substrate in the exposure apparatus shown in FIG. 1.

FIG. 5 is a graph illustrating an example of a first table indicating the relationship between the position of the stage and the disturbance magnetic field fluctuation on the electron beam path between the electron optical system and the substrate in the exposure apparatus shown in FIG. 1.

FIG. 6 is a view illustrating an example of the arrangement of a Helmholtz coil.

FIG. 7 is a table showing the relationship between the magnetic field on the electron beam path between the electron optical system and the substrate and that at the position of a detection unit in the exposure apparatus shown in FIG. 1.

FIG. 8 is a block diagram showing a control configuration for reducing a magnetic field fluctuation on the electron beam path between the electron optical system and the substrate.

FIG. 9 is a view showing the arrangement of a magnetic field canceller according to the prior art.

### DESCRIPTION OF EMBODIMENTS

Preferred embodiments of the present invention will be described below with reference to the accompanying drawings. Note that the same reference numerals denote the same members throughout the drawings, and a repetitive description thereof will not be given.

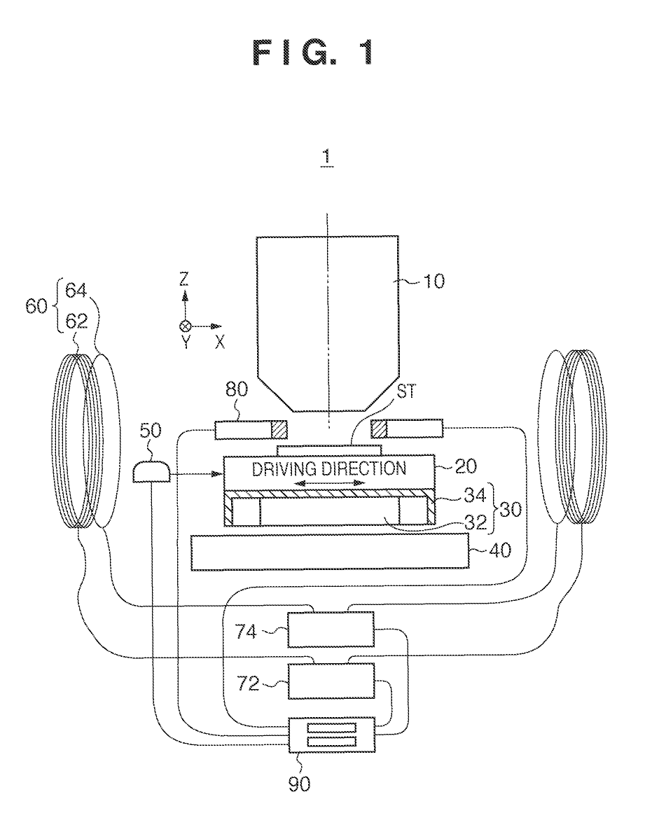

FIG. 1 is a view showing the arrangement of an exposure apparatus 1 according to an aspect of the present invention. The exposure apparatus 1 is an electron beam exposure apparatus which is accommodated in a vacuum chamber having its interior maintained in a vacuum atmosphere, and forms a pattern on a substrate using an electron beam (charged particle beam). The exposure apparatus 1 includes an electron optical system 10 which guides an electron beam onto a substrate ST, a stage (substrate stage) 20 which holds the substrate ST, a driving unit 30 which drives the stage 20, a stage base 40, and a measurement unit 50 which measures the position of the stage 20. The exposure apparatus 1 also includes a coil unit 60 which generates a magnetic field on the electron beam path between the electron optical system 10 and the substrate ST, a first power supply 72, a second power supply 74, a detection unit 80, and a control unit 90.

The stage 20 includes, on its upper surface, a substrate holder (not shown) for holding the substrate ST, and, on its side surface, a reflecting mirror (not shown) for measuring the position of the stage 20. A bearing (not shown) is placed between the stage 20 and the stage base 40, and the driving unit 30 smoothly drives the stage 20 in the X- and Y-axis directions along the upper surface of the stage base 40.

The driving unit 30 includes an electromagnetic actuator 32 fixed on the stage 20 and a magnetic shield 34 which surrounds the electromagnetic actuator 32, and drives the stage 20 in the X- and Y-axis directions perpendicular to the optical path of the electron beam (Z-axis direction). The electromagnetic actuator 32 is formed from, for example, a linear motor, an electromagnet actuator, or a planar motor. The electromagnetic actuator 32 generates an electromagnetic force by energization to generate a thrust in the X- and Y-axis directions between itself and the stage base 40. The magnetic shield 34 is made of a high magnetic permeability material such as soft iron, and covers members which generate a magnetic field, such as magnets and coils that constitute the electromagnetic actuator 32. Note that in the stage 20 and driving unit 30, members other than the electromagnetic actuator 32 are basically made of a non-magnetic material. Therefore, the magnetic shield 34 can reduce (attenuate) most components of a disturbance magnetic field running from the stage 20 and driving unit 30 to the optical path of the electron beam.

The measurement unit 50 is formed from, for example, a laser interferometer, and measures the position of the stage 20 in the X- and Y-axis directions upon receiving light reflected by the reflecting mirror provided on the stage 20. Although only a measurement unit (that is, a measurement axis in the X-axis direction) which measures the position of the stage 20 in the X-axis direction is shown in FIG. 1 as the measurement unit 50, a measurement unit (that is, a measurement axis in the Y-axis direction) which measures the position of the stage 20 in the Y-axis direction is also disposed.

The coil unit 60 functions as a magnetic field canceller which reduces (cancels) a fluctuation of a magnetic field (magnetic field fluctuation) on the electron beam path between the electron optical system 10 and the substrate ST in cooperation with, for example, the measurement unit 50, first power supply 72, second power supply 74, detection unit 80, and control unit 90. The coil unit 60 includes a first coil 62 which generates a magnetic field having a first amplitude, and a second coil 64 which generates a magnetic field having a second amplitude smaller than the first amplitude, as shown in FIG. 1.

The first coil 62 is formed from, for example, two Helmholtz coils which are aligned with a space between them in the X-axis direction, and the electron beam path is positioned in the middle between these two Helmholtz coils. The first coil 62 can generate a magnetic field in the X-axis direction by energization by the first power supply 72, and can generate an almost uniform magnetic field within the X-Y plane defined by a cross-section of the electron beam path. The second coil 64 includes two Helmholtz coils which are aligned with a space between them in the X-axis direction, and the electron beam path is positioned in the middle between these two Helmholtz coils, like the first coil 62. The second coil 64 can generate a magnetic field in the X-axis direction by energization by the second power supply 74.

In this embodiment, the number of turns of the first coil 62 is set larger than that of the second coil 64. Thus, the first coil 62 can generate a magnetic field with a large amplitude (first amplitude) even when the first power supply 72 and second power supply 74 have the same output range. Also, the second coil 64 can generate a magnetic field with a small amplitude (second amplitude) with high accuracy even when the first power supply 72 and second power supply 74 have the same output range or output resolution.

The detection unit 80 is placed in the space between the electron optical system 10 and the substrate ST, and detects a magnetic field (components of a disturbance magnetic field fluctuation in the X- and Y-axis directions) on the electron beam path between the electron optical system 10 and the substrate ST. The detection unit 80 is formed from a magnetic sensor and covered with a non-magnetic material (for example, aluminum, phosphor bronze, stainless steel, a resin, or ceramics) with less degassing.

The control unit 90 includes, for example, a CPU and memory and controls the whole (operation) of the exposure apparatus 1. The control unit 90 determines current values to be supplied to the first coil 62 and second coil 64, respectively, based on the measurement result obtained by the measurement unit 50 and the detection result obtained by the detection unit 80, and controls the first power supply 72 and second power supply 74 which energize the first coil 62 and second coil 64, respectively. As will be described later, the control unit 90 includes a feedforward control system and feedback control system for magnetic fields generated by the coil unit 60. The feedforward control system feedforward-controls a magnetic field, generated by the first coil 62, so as to generate a magnetic field which reduces a magnetic field fluctuation generated on the electron beam path upon driving the stage 20, based on the position of the stage 20 measured by the measurement unit 50. Also, the feedback control system feedback-controls a magnetic field, generated by the second coil 64, so as to generate a magnetic field which reduces a magnetic field fluctuation generated on the electron beam path upon driving the stage 20, based on the magnetic field detected by the detection unit 80.

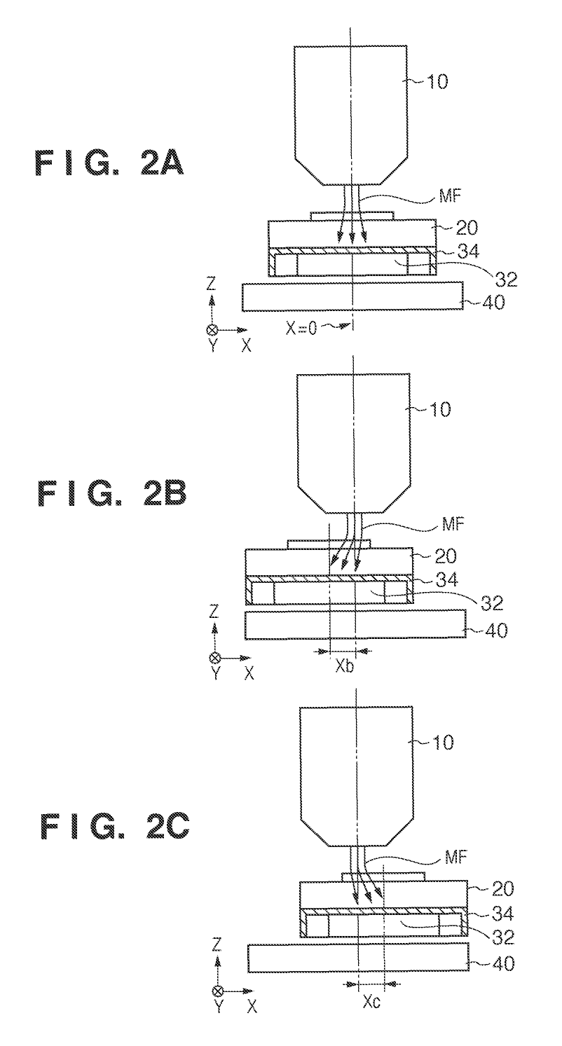

A magnetic field fluctuation (disturbance magnetic field fluctuation) on the electron beam path between the electron optical system 10 and the substrate ST will be described herein with reference to FIGS. 2A to 2C. The stage 20 is provided with the electromagnetic actuator 32 and the magnetic shield 34 which is made of a high magnetic permeability material, as described above. Note that a leakage magnetic field MF leaked from the electron optical system 10 is always present in the space between the electron optical system 10 and the substrate ST, so the stage 20 is driven in the X- and Y-axis directions within the leakage magnetic field MF. This means that the magnetic shield 34 made of a high magnetic permeability material moves in the X- and Y-axis directions within the leakage magnetic field MF.

FIGS. 2A to 2C schematically show a fluctuation in leakage magnetic field MF (its distribution) upon driving the stage 20 in the X-axis direction. FIG. 2A shows the leakage magnetic field MF when the stage 20 is positioned in the middle of a moving stroke of the stage 20. The position (the position in the X-axis direction) of the stage 20 at this time is defined as X=0, and the disturbance magnetic field fluctuation at this time is defined as ΔB=0 assuming the magnetic field value on the electron beam path as a reference.

A case in which the stage 20 moves from the position X=0 to a position X=Xb (<0) to move the magnetic shield 34 in the negative X-axis direction, as shown in FIG. 2B, will be considered. In this case, the leakage magnetic field MF is attracted to the magnetic shield 34 which is positioned in the negative X-axis direction relative to the optical axis of the electron optical system 10. With such a change in leakage magnetic field MF (its distribution), a negative X-axis component is generated in the leakage magnetic field MF, so the disturbance magnetic field fluctuation on the electron beam path becomes ΔB=ΔB×b (<0).

A case in which the stage 20 moves from the position X=0 to a position X=Xc (>0) to move the magnetic shield 34 in the positive X-axis direction, as shown in FIG. 2C, will be considered next. In this case, the leakage magnetic field MF is attracted to the magnetic shield 34 which is positioned in the positive X-axis direction relative to the optical axis of the electron optical system 10. With such a change in leakage magnetic field MF (its distribution), a positive X-axis component is generated in the leakage magnetic field MF, so the disturbance magnetic field fluctuation on the electron beam path becomes ΔB=ΔB×c (>0).

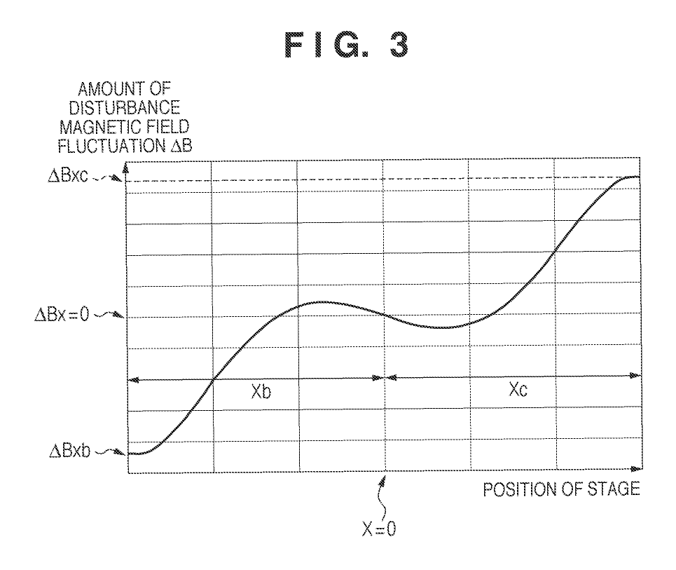

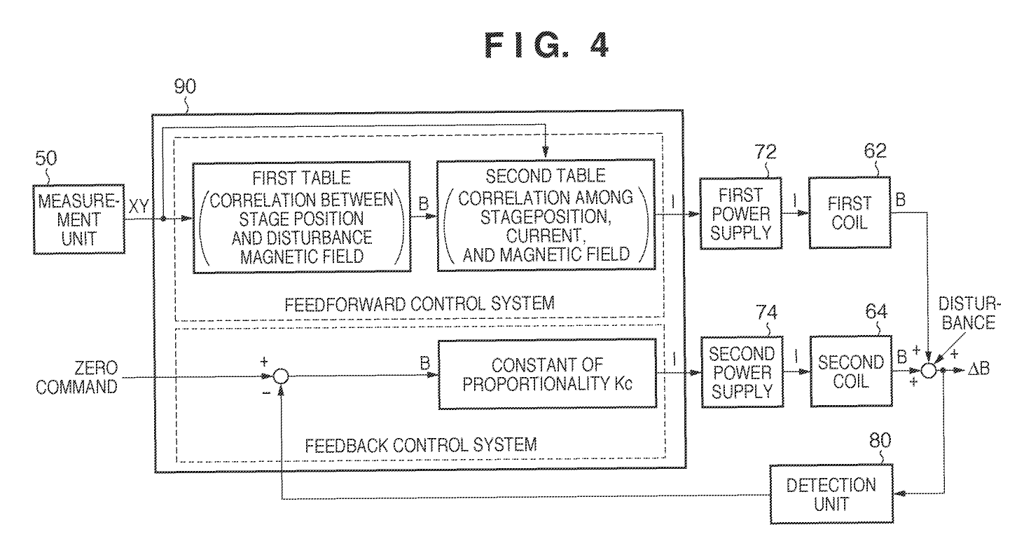

FIG. 3 is a graph illustrating an example of the relationship between the position of the stage 20 and the amount of disturbance magnetic field fluctuation ΔB on the electron beam path between the electron optical system 10 and the substrate ST. FIG. 3 shows the position X of the stage 20 on the abscissa and the amount of disturbance magnetic field fluctuation ΔB on the ordinate. Referring to FIG. 3, the amount of disturbance magnetic field fluctuation ΔB as a function of the position X of the stage 20 is ΔB=0 when X=0, ΔB=ΔB×b when X=Xb, and ΔB=ΔB×c when X=Xc. The disturbance magnetic field fluctuation generated due to factors associated with both the leakage magnetic field MF and movement of the stage 20 (magnetic shield 34) can be expressed as a function of the position of the stage 20, as shown in FIG. 3. Note that if a leakage magnetic field leaked from a permanent magnet which serves as a constituent element of the electromagnetic actuator 32 and is fixed on the stage 20 reaches the electron beam path, and this leads to a magnetic field fluctuation, this magnetic field fluctuation is also generated in correspondence with the position of the stage 20 and therefore can be expressed as a function of the position of the stage 20.

FIG. 4 is a block diagram showing a control configuration for reducing (cancelling) a magnetic field fluctuation (distributed magnetic field fluctuation) on the electron beam path between the electron optical system 10 and the substrate ST in the exposure apparatus 1. Referring to FIG. 4, upon driving the stage 20, the measurement unit 50 measures the position (the position in the X- and Y-axis directions) of the stage 20 and inputs the measurement result to the control unit 90.

The feedforward control system of the control unit 90 controls a magnetic field, generated by the coil unit 60 (first coil 62), so as to generate a magnetic field which reduces a disturbance magnetic field fluctuation generated upon driving the stage 20, based on the position of the stage 20 measured by the measurement unit 50.

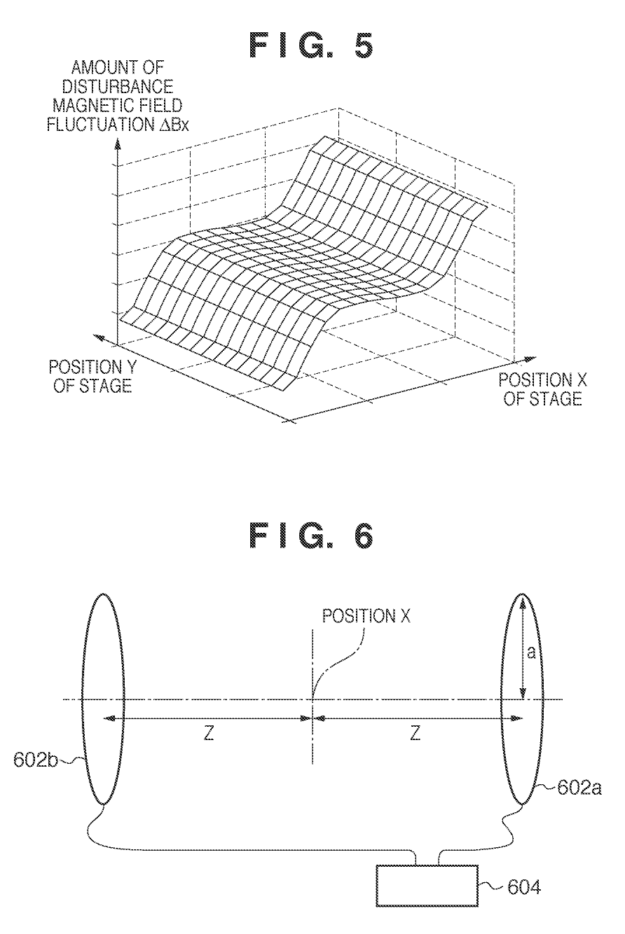

Detailed control by the feedforward control system will be explained herein. The memory of the control unit 90 stores, in advance, a first table indicating the relationship between the position of the stage 20 and the disturbance magnetic field fluctuation on the electron beam path between the electron optical system 10 and the substrate ST. The first table is, for example, a table which shows the position of the stage 20 in the X- and Y-axis directions on the two horizontal axes, and the amount of disturbance magnetic field fluctuation ΔBx on the vertical axis, as shown in FIG. 5. Note that the first table can be created by driving the stage 20 while measuring the position of the stage 20 by the measurement unit 50 and detecting an amount of disturbance magnetic field fluctuation ΔBx at each position of the stage 20 by the detection unit 80, while the coil unit 60 generates no magnetic field.

The memory of the control unit 90 also stores, in advance, a second table indicating the relationship among the position of the stage 20, the current value supplied to the first coil 62, and the magnetic field (magnetic field value) generated by the first coil 62. The second table is, for example, a table which shows the position of the stage 20 in the X- and Y-axis directions on the two horizontal axes, and the constant of proportionality Kb given by (the current value supplied to the first coil 62)/(the magnetic field value generated by the first coil 62) on the vertical axis. Note that the second table can be created by driving the stage 20 while measuring the position of the stage 20 by the measurement unit 50 to obtain a constant of proportionality Kb while changing the current value supplied to the first coil 62 at each position of the stage 20.

The feedforward control system looks up the first table to obtain an amount of disturbance magnetic field fluctuation ΔB corresponding to the position of the stage 20 measured by the measurement unit 50. The feedforward control system determines, as a magnetic field to be generated by the first coil 62, a magnetic field which is equal in absolute value and opposite in direction to the amount of disturbance magnetic field fluctuation ΔB corresponding to the position of the stage 20, and generates a command value used to generate this magnetic field. The feedforward control system looks up the second table to obtain a constant of proportionality Kb corresponding to the position of the stage 20 measured by the measurement unit 50, and multiplies the constant of proportionality Kb by the above-mentioned command value to obtain a current value to be supplied to the first coil 62. The feedforward control system inputs the obtained current value as a current command value for the first power supply 72. The first power supply 72 energizes the first coil 62 based on the current command value from the feedforward control system. Thus, the first coil 62 generates a magnetic field which reduces (cancels) a disturbance magnetic field fluctuation generated on the electron beam path between the electron optical system 10 and the substrate ST upon driving the stage 20.

A magnetic field generated on the electron beam path between the electron optical system 10 and the substrate ST by the first coil 62 cancels a disturbance magnetic field fluctuation generated upon driving the stage 20. However, the magnetic field generated by the first coil 62 sometimes cannot perfectly cancel the disturbance magnetic field fluctuation, thus generating a magnetic field fluctuation residual.

In this case, the feedback control system of the control unit 90 controls a magnetic field, generated by the coil unit 60 (second coil 64), so as to generate a magnetic field which reduces a magnetic field fluctuation residual, based on the magnetic field detected by the detection unit 80. Detailed control by the feedback control system will be explained herein. While the feedforward control system performs feedforward control, the detection unit 80 detects a magnetic field on the electron beam path between the electron optical system 10 and the substrate ST, and inputs the detection result to the control unit 90.

The feedback control system obtains a deviation between the command value used to cancel the disturbance magnetic field fluctuation to zero and the magnetic field (its fluctuation) detected by the detection unit 80, and multiplies the deviation by a constant of proportionality Kc to obtain a current value to be supplied to the second coil 64. The feedback control system inputs the obtained current value as a current command value for the second power supply 74. The second power supply 74 energizes the second coil 64 based on the current command value from the feedback control system. Thus, the second coil 64 generates a magnetic field which reduces (cancels) a magnetic field fluctuation residual, that is, a disturbance magnetic field fluctuation generated on the electron beam path between the electron optical system 10 and the substrate ST upon driving the stage 20.

The exposure apparatus 1 according to this embodiment feedforward-controls a magnetic field generated by the first coil 62, based on the position of the stage 20, to generate a magnetic field which reduces (cancels) a disturbance magnetic field fluctuation generated upon driving the stage 20. Therefore, the exposure apparatus 1 can reduce (cancel) a disturbance magnetic field fluctuation generated upon driving the stage 20, without detecting a magnetic field (its fluctuation) on the electron beam path between the electron optical system 10 and the substrate ST by the detection unit 80. Also, when a magnetic field fluctuation residual occurs as a magnetic field generated by the first coil 62 cannot cancel a disturbance magnetic field fluctuation, a magnetic field generated by the second coil 64 is feedback-controlled based on the magnetic field detected by the detection unit 80. Note that the magnetic field fluctuation residual is not a disturbance magnetic field fluctuation (a disturbance magnetic field fluctuation with a large amplitude) corresponding to the position of the stage 20, but a magnetic field fluctuation which has a small amplitude and is obtained by superposing the disturbance magnetic field fluctuation corresponding to the position of the stage 20 and the magnetic field generated by the first coil 62. Therefore, the detection unit 80 can detect a magnetic field (that is, a magnetic field fluctuation residual) on the electron beam path between the electron optical system 10 and the substrate ST without suffering from an insufficient detection range.

In this manner, because the exposure apparatus 1 can accurately reduce (cancel) a magnetic field fluctuation generated on the electron beam path between the electron optical system 10 and the substrate ST upon driving the stage 20, it can form a pattern on the substrate ST with high accuracy. Hence, the exposure apparatus 1 can provide high-quality devices (for example, a semiconductor device and a liquid crystal display device) with a high throughput and good economical efficiency. These devices are fabricated by a step of exposing a substrate (for example, a wafer or a glass plate) coated with a photoresist (photosensitive agent) using the exposure apparatus 1, a step of developing the exposed substrate, and subsequent known steps.

Although the output ranges of magnetic fields generated by the first coil 62 and second coil 64, respectively, are set in accordance with the numbers of turns of these coils in this embodiment, the present invention is not limited to this. For example, a power supply with an output range wider than that of the second power supply 74 which energizes the second coil 64 may be used as the first power supply 72 which energizes the first coil 62. It is also possible to set the output ranges of these power supplies in accordance with, for example, the shapes and arrangements of the first coil 62 and second coil 64, respectively. FIG. 6 is a view illustrating a Helmholtz coil which includes coils 602a and 602b that are aligned with a space between them and generates a magnetic field in a direction parallel to the coil axis by energization by a power supply 604. Letting a be the radius of the coils 602a and 602b, and Z×2 be their distance, the magnetic field B in a direction parallel to the coil axis at the position X is given by:

$$B = \frac{{μ}_{0} \cdot I \cdot {a}^{2}}{{( {a}^{2} + {Z}^{2} )}^{3 / 2}} \qquad ( 1 )$$

where μ₀ is the magnetic permeability in a vacuum, and I is the current value. As can be seen from equation (1), the magnetic field B decreases as the distance between the coils 602a and 602b increases. Therefore, the output range of a magnetic field generated by the first coil 62 can be widened by setting the position (the position in the X-axis direction) of the first coil 62 to be closer to the electron beam path than the position (the position in the X-axis direction) of the second coil 64. The output range of a magnetic field generated by the first coil 62 can also be widened by appropriately changing the radius of the first coil 62 or the distance between the coils.

In this embodiment, the detection unit 80 detects a magnetic field (its fluctuation) on the electron beam path between the electron optical system 10 and the substrate ST. However, because the detection unit 80 is placed in the space between the electron optical system 10 and the substrate ST, it does not detect an exact magnetic field on the electron beam path between the electron optical system 10 and the substrate ST. Hence, the detection accuracy of the detection unit 80 can be improved by correcting a deviation of the magnetic field fluctuation due to the difference between the electron beam path and the position of the detection unit 80. Thus, the coil unit (second coil 64) can more accurately generate a magnetic field which reduces a disturbance magnetic field fluctuation (that is, a magnetic field fluctuation residual) generated upon driving the stage 20.

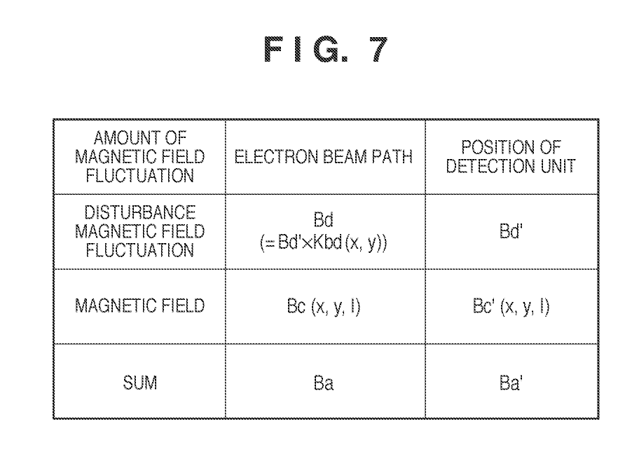

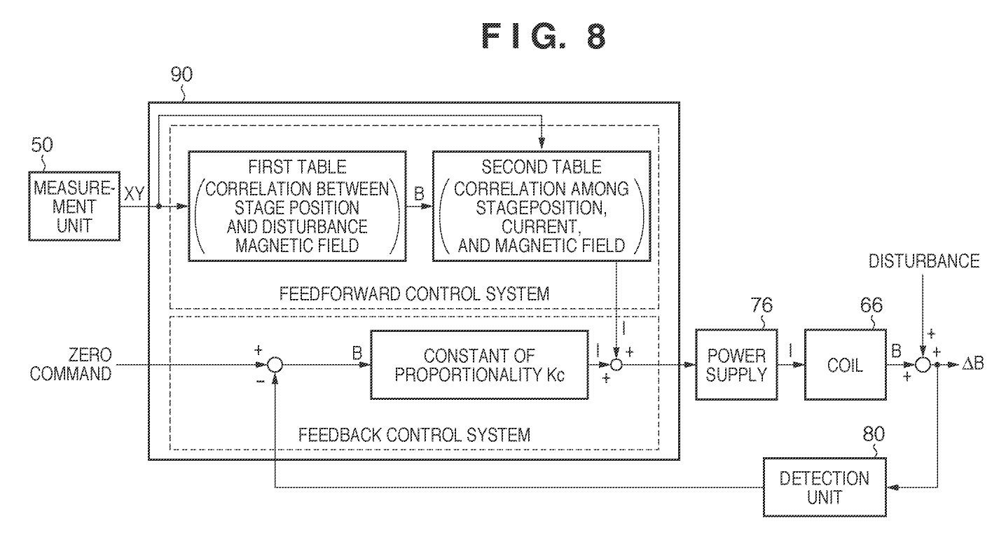

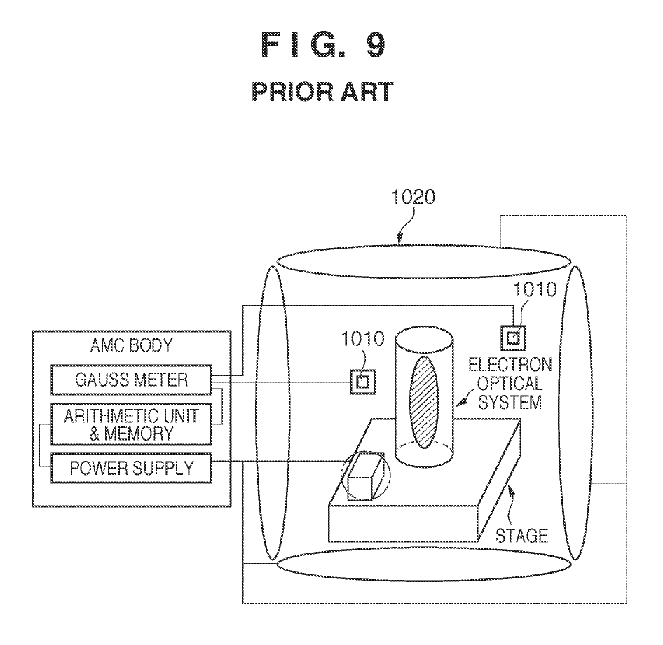

FIG. 7 is a table showing the relationship between the magnetic field (its value) on the electron beam path between the electron optical system 10 and the substrate ST and that at the position of the detection unit 80. Let Ba be the magnetic field fluctuation on the electron beam path, and Ba′ be the magnetic field fluctuation at the position of the detection unit 80 at that time. Also, let Bc be the magnetic field on the electron beam path upon supplying a given current value to the coil unit 60, and Bc′ be the magnetic field at the position of the detection unit 80 at that time. Moreover, let Bd be the disturbance magnetic field fluctuation on the electron beam path upon driving the stage 20, and Bd′ be the disturbance magnetic field fluctuation at the position of the detection unit 80 at that time. Note that the amount of magnetic field fluctuation Ba on the electron beam path satisfies a relation: Ba=Bd+Bc, and the amount of magnetic field fluctuation Ba′ at the position of the detection unit 80 at that time satisfies a relation: Ba′=Bd′+Bc′.

The relationship among the magnetic field Bc, the position (x, y) of the stage 20, and the current I supplied to the coil unit 60 is obtained and stored in the memory of the control unit 90 in advance as a table L. Thus, a magnetic field Bc(x, y, I) corresponding to the position (x, y) of the stage 20 and the current I can be obtained by looking up the table L.

Also, the relationship among the magnetic field Bc′, the position (x, y) of the stage 20, and the current I supplied to the coil unit 60 is obtained and stored in the memory of the control unit 90 in advance as a table L′. Thus, a magnetic field Bc′(x, y, I) corresponding to the position (x, y) of the stage 20 and the current I can be obtained by looking up the table L′.

Moreover, the relationship between the disturbance magnetic field fluctuations Bd and Bd′ and the position (x, y) of the stage 20 is obtained, and a correction coefficient Kbd(x, y)=Bd/Bd′ is stored in the memory of the control unit 90 in advance as a table M. Thus, a correction coefficient Kbd(x, y) corresponding to the position (x, y) of the stage 20 can be obtained by looking up the table M.

A procedure for obtaining an amount of magnetic field fluctuation Ba on the electron beam path based on the position (x, y) of the stage 20 and the amount of magnetic field fluctuation Ba′ when the stage 20 is at an arbitrary position (x, y) will be described.

First, a magnetic field Bc′(x, y, I) corresponding to both the position (x, y) of the stage 20 and the current I is obtained by looking up the table L′. From the amount of magnetic field fluctuation Ba′ and magnetic field Bc′, a disturbance magnetic field fluctuation Bd′ is obtained in accordance with:

Bd′=Ba′−Bc′(x,y,I) (2)

Next, a correction coefficient Kbd(x, y) corresponding to the position (x, y) of the stage 20 is obtained by looking up the table M. From the disturbance magnetic field fluctuation Bd′ and correction coefficient Kbd(x, y), a disturbance magnetic field fluctuation Bd is obtained in accordance with:

Bd=Kbd(x,y)×Bd′ (3)

Lastly, a magnetic field Bc(x, y, I) corresponding to the position (x, y) of the stage 20 and the current I is obtained by looking up the table L. From the disturbance magnetic field fluctuation Bd and magnetic field Bc, an amount of magnetic field fluctuation Ba is obtained in accordance with:

Ba=Bd−Bc(x,y,I) (4)

In this way, a magnetic field fluctuation on the electron beam path can be obtained with high accuracy by correcting the amount of magnetic field fluctuation Ba′ (that is, the magnetic field detected by the detection unit 80) at the position of the detection unit 80 to the amount of magnetic field fluctuation Ba in the electron beam path.

Although a disturbance magnetic field fluctuation in the X-axis direction is reduced (canceled) in this embodiment, a disturbance magnetic field fluctuation in the Y-axis direction can similarly be reduced by providing the above-mentioned arrangement for the Y-axis direction.

Also, the first coil 62 and second coil 64 can be replaced with a single coil 66, and the first power supply 72 and second power supply 74 can be replaced with a single power supply 76, as shown in FIG. 8. Note that the coil 66 has the functions of both the first coil 62 and second coil 64, and the power supply 76 has a function of energizing the coil 66. Referring to FIG. 8, upon driving the stage 20, the measurement unit 50 measures the position (the position in the X- and Y-axis directions) of the stage 20 and inputs the measurement result to the control unit 90. While the feedforward control system performs feedforward control, the detection unit 80 detects a magnetic field on the electron beam path between the electron optical system 10 and the substrate ST, and inputs the detection result to the control unit 90.

As described above, the memory of the control unit 90 stores, in advance, a first table indicating the relationship between the position of the stage 20 and the disturbance magnetic field fluctuation on the electron beam path between the electron optical system 10 and the substrate ST. The memory of the control unit 90 also stores, in advance, a second table indicating the relationship among the position of the stage 20, the current value supplied to the first coil 62, and the magnetic field (magnetic field value) generated by the first coil 62.

The feedforward control system looks up the first table to obtain an amount of disturbance magnetic field fluctuation ΔB corresponding to the position of the stage 20 measured by the measurement unit 50. The feedforward control system determines, as a magnetic field to be generated by the first coil 62, a magnetic field which is equal in absolute value and opposite in direction to the amount of disturbance magnetic field fluctuation ΔB corresponding to the position of the stage 20, and generates a command value used to generate this magnetic field. The feedforward control system looks up the second table to obtain a constant of proportionality Kb corresponding to the position of the stage 20 measured by the measurement unit 50, and multiplies the constant of proportionality Kb by the above-mentioned command value to obtain a current value to be supplied to the first coil 62. The feedforward control system inputs the obtained current value as a current command value for the first power supply 72.

On the other hand, the feedback control system obtains a deviation between the command value used to cancel the disturbance magnetic field fluctuation to zero and the magnetic field (its fluctuation) detected by the detection unit 80, and multiplies the deviation by a constant of proportionality Kc to obtain a current value to be supplied to the second coil 64. The feedback control system inputs the obtained current value as a current command value for the second power supply 74.

The power supply 76 energizes the coil 66 based on the sum total of the current command value from the feedforward control system and that from the feedback control system. Thus, the coil 66 generates a magnetic field which reduces (cancels) a disturbance magnetic field fluctuation (including the above-mentioned magnetic field fluctuation residual) generated on the electron beam path between the electron optical system 10 and the substrate ST upon driving the stage 20.

In this manner, feedforward control based on the position of the stage 20 measured by the measurement unit 50 prevents generation of a magnetic field fluctuation with a large amplitude on the electron beam path between the electron optical system 10 and the substrate ST so that the amplitude of the magnetic field fluctuation falls within the detection range of the detection unit 80. After that, feedback control based on the magnetic field detected by the detection unit 80 reduces (cancels) a magnetic field fluctuation with a small amplitude on the electron beam path between the electron optical system 10 and the substrate ST. The control configuration shown in FIG. 8 is effective when the magnetic field generated by the coil 66 (and the power supply 76) has a sufficient output range and resolution and the detection unit 80 has an insufficient detection range.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-145529 filed on Jun. 25, 2010, which is hereby incorporated by reference herein in its entirety.

1. An exposure apparatus which forms a pattern on a substrate using a charged particle beam, the apparatus comprising:
an electron optical system configured to guide the charged particle beam onto the substrate;
a stage configured to hold the substrate;
an electromagnetic actuator configured to drive the stage;
a magnetic shield which is placed in the stage so as to surround the electromagnetic actuator;
a measurement member configured to measure a position of the stage;
a coil member configured to generate a magnetic field on a path of the charged particle beam between the electron optical system and the substrate; and
a control member configured to control the coil member so as to reduce a fluctuation of the magnetic field on the path, the magnetic field on the path fluctuating while the stage being driven by the electromagnetic actuator, based on the position of the stage measured by the measurement member.

2. The apparatus according to claim 1, wherein
the control member includes a feedforward control system configured to look up a table indicating a relationship between the position of the stage and the fluctuation of the magnetic field on the path to obtain the fluctuation of the magnetic field corresponding to the position of the stage, thereby feedforward-controlling the magnetic field, generated by the coil member, so as to reduce the fluctuation of the magnetic field.

3. The apparatus according to claim 2, further comprising:
a detection member configured to detect the magnetic field on the path,
wherein the control member further includes a feedback control system configured to feedback-control the magnetic field, generated by the coil member, so as to reduce the fluctuation of the magnetic field on the path, the magnetic field on the path fluctuating while the stage being driven by the electromagnetic actuator, based on the magnetic field detected by the detection member.

4. The apparatus according to claim 3, wherein
the coil member includes
a first coil configured to generate a magnetic field having a first amplitude, and
a second coil configured to generate a magnetic field having a second amplitude smaller than the first amplitude,
the feedforward control system feedforward-controls the magnetic field, generated by the first coil, so as to reduce the fluctuation of the magnetic field on the path, the magnetic field on the path fluctuating while the stage being driven by the electromagnetic actuator, and
the feedback control system feedback-controls the magnetic field, generated by the second coil, so as to reduce the fluctuation of the magnetic field on the path, the magnetic field on the path fluctuating while the stage being driven by the electromagnetic actuator.

5. An exposure apparatus which forms a pattern on a substrate using a charged particle beam, the apparatus comprising:
an electron optical system configured to guide the charged particle beam onto the substrate;
a stage configured to hold the substrate, the stage being driven by an electromagnetic actuator, and having a high magnetic permeability material placed thereon;
a coil member configured to generate a magnetic field on a path of the charged particle beam; and
a control member configured to control the coil member based on a position of the stage.

6. A device fabrication method comprising steps of:
exposing a substrate using an exposure apparatus; and
performing a development process for the substrate exposed,
wherein the exposure apparatus which forms a pattern on the substrate using a charged particle beam, and includes:
an electron optical system configured to guide the charged particle beam onto the substrate;
a stage configured to hold the substrate;
an electromagnetic actuator configured to drive the stage;
a magnetic shield which is placed in the stage so as to surround the electromagnetic actuator;
a measurement member configured to measure a position of the stage;
a coil member configured to generate a magnetic field on a path of the charged particle beam between the electron optical system and the substrate; and
a control member configured to control the coil member so as to reduce a fluctuation of the magnetic field on the path, the magnetic field on the path fluctuating while the stage being driven by the electromagnetic actuator, based on the position of the stage measured by the measurement member.

7. A device fabrication method comprising steps of:
exposing a substrate using an exposure apparatus; and
performing a development process for the substrate exposed,
wherein the exposure apparatus which forms a pattern on the substrate using a charged particle beam, and includes:
an electron optical system configured to guide the charged particle beam onto the substrate;
a stage configured to hold the substrate, the stage being driven by an electromagnetic actuator, and having a high magnetic permeability material placed thereon;
a coil member configured to generate a magnetic field on a path of the charged particle beam; and
a control member configured to control the coil member based on a position of the stage.
